(19) United States
(12) Patent Application Publication
(10) Pub. No.: US 2025/0315508 A1
(43) Pub. Date: Oct. 9, 2025

(54) LINK SERVICE FOR PROVIDING ACCESS TO CONTENT UNDER AGREED POLICY TERMS ASSOCIATED WITH CUSTOMIZED LINKS

(71) Applicant: Smarter License, Inc., Sun Valley, CA (US)

(72) Inventor: Elizabeth Hagelthorn, Sun Valley, CA (US)

(73) Assignee: Smarter License, Inc., Sun Valley, CA (US)

(21) Appl. No.: 19/169,130

(22) Filed: Apr. 3, 2025

Related U.S. Application Data
(60) Provisional application No. 63/575,147, filed on Apr. 5, 2024.

(51) Int. Cl. G06F 21/10

(52) U.S. Cl. CPC G06F 21/1084; G06F 21/1062

(57) ABSTRACT

The present technology pertains to managing digital content access and distribution under dynamically enforceable policy terms. The present technology includes a link service that enables rights holders to control access to their content through smart links, which serve as policy-governed access points rather than direct content transfers. A Smart link configuration user interface allows rights holders to define policy terms, including licensing conditions, attribution requirements, and access restrictions. The system integrates with a content management system, where content is stored with embedded metadata containing access control configurations. A Smart link-management user interface enables real-time monitoring, modification, and revocation of smart links, allowing rights holders to dynamically enforce content usage terms even after content has been shared.

### CROSS-REFERENCE TO RELATED APPLICATIONS

This application claims the benefit of and priority to U.S. provisional application No. 63/575,147, filed on Apr. 5, 2024, which is expressly incorporated by reference herein in its entirety.

### BACKGROUND

The current state of the art in content provenance and usage on the Internet is challenged by the vast amounts of data being generated, which obscures the ability to discern authentic content from manipulated material. The proliferation of sophisticated AI tools exacerbates this issue by making it increasingly difficult to verify the originality of content. Furthermore, rights holders face considerable limitations in preventing their data from being used without permission to train AI models or in the unauthorized derivation of new works.

### BRIEF DESCRIPTION OF THE SEVERAL VIEWS OF THE DRAWINGS

Details of one or more embodiments of the subject matter described in this disclosure are set forth in the accompanying drawings and the description below. However, the accompanying drawings illustrate only some typical embodiments of this disclosure and are therefore not to be considered limiting of its scope. Other features, embodiments, and advantages will become apparent from the description, the drawings and the claims.

FIG. 1A illustrates an example system in which a link service facilitates the management, distribution, and controlled access of content stored in a public cloud in accordance with some embodiments of the present technology.

FIG. 1B illustrates another example system in which a link service facilitates the management, distribution, and controlled access of content stored in a public cloud in accordance with some embodiments of the present technology.

FIG. 2 illustrates an example routine for configuring content for management by the link service and for storing the content in a public cloud in a way that permits public user access to the content with management of the access by the link service in accordance with some embodiments of the present technology.

FIG. 3 illustrates an example of a smart link configuration user interface in accordance with some embodiments of the present technology.

FIG. 4 illustrates an example of a license manager that shows a portion of a license embodied in computer code format in accordance with some embodiments of the present technology.

FIG. 5 illustrates an example routine for creating a smart link associated with the content and the agreed policy terms and providing access to the content when requested through interacting with the smart link in accordance with some embodiments of the present technology.

FIG. 6 illustrates an example smart link configuration user interface in accordance with some embodiments of the present technology.

FIG. 7 illustrates an example of a smart link-management user interface for managing smart links of the content by the rights holder, and for viewing data pertaining to access of the content by the smart links in accordance with some embodiments of the present technology.

FIG. 8 illustrates an example routine for facilitating acceptance and/or negotiation of policy terms and for obtaining access to the content under the agreed policy terms in accordance with some embodiments of the present technology.

FIG. 9 illustrates an example user interface for selecting policy terms and/or negotiating custom terms for the content in accordance with some embodiments of the present technology.

FIG. 10 is an example policy agreement form in accordance with some embodiments of the present technology.

FIG. 11 illustrates an example routine for providing access to the content and permitting uses of the content that are permitted by the agreed policy terms in accordance with some embodiments of the present technology.

FIG. 12 illustrates an example routine for providing a smart link-management user interface and for managing access to the content and derivatives of the content in accordance with some embodiments of the present technology.

FIG. 13 illustrates an example of a rights holder management user interface for managing smart links of contents by the rights holder in accordance with some embodiments of the present technology.

FIG. 14 shows an example of a system for implementing some embodiments of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The current state of the art in content provenance and usage of content on the Internet is challenged by the vast amounts of data being generated, which obscures the ability to discern authentic content from manipulated content. The proliferation of sophisticated AI tools exacerbates this issue by making it increasingly difficult to verify the originality of content. Furthermore, rights holders face considerable limitations in preventing their content from being used without permission to train AI models or in the unauthorized derivation of new content.

Managing the distribution and use of digital content on the Internet faces several challenges. It is easy for content to be copied and used without authorization. Even when the content owner is willing to allow the use of their content, it can be hard to get such permission from the content owner. Even if the content owner gives permission for their content to be used, the content owner has little ability to ensure that the content is used as intended.

While some partial solutions exist, none adequately solve these problems. For example, content can be hosted from a single source, and can be associated with policies that can make it harder to copy content. However, such systems are not easy to use because they require the creation of sophisticated access and rights policies that are often only configurable by those with specialized knowledge. Knowledge and content owners typically don't possess. Such systems can also charge a lot to host the content.

Furthermore, these hosting solutions are often content-centric (focused on serving content according to defined access policies) but are not content-owner-centric. Content owners need to protect and manage their content. Hosting solutions do not consider derivative content to be related to original content, but this can be important to a content owner. Content owners want to know how often their content is being accessed and by whom to ensure proper royalty payments are being made. Content owners also want their content to be accessible to the public for certain uses but not others (e.g., a content owner might want their image to be publicly viewable online but not viewable by an AI tool for training). Traditional hosting solutions fail to meet these needs and more.

The present technology addresses these needs by introducing a link service that centralizes content access under defined policy terms, ensuring that rights holders maintain control over their content while allowing authorized users to interact with the content in a structured and transparent manner.

The present technology utilizes smart links, which act as controlled access points to content. Instead of distributing content copies, the system enables distribution through access-controlled links, which can be dynamically modified or revoked by the rights holder at any time. Additionally, content metadata includes policy terms that enforce conditions such as attribution requirements, read-only permissions, or restrictions on AI training.

The present technology also provides real-time tracking and logging capabilities, enabling content owners to monitor usage statistics, including access history, geographic distribution, and referring websites. Additionally, the Smart link-management user interface allows rights holders to modify or revoke access to content if they detect misuse or policy violations. This functionality ensures that content remains under the control of the original creator, even after it has been widely shared.

One major challenge in the digital landscape is the risk of content being used for AI training or remixing without permission. The system introduces AI-specific licensing terms, allowing rights holders to define whether their content can be accessed by AI models and under what conditions. Furthermore, the system supports hierarchical licensing, ensuring that derivative content remain linked to the original creator's rights and ownership.

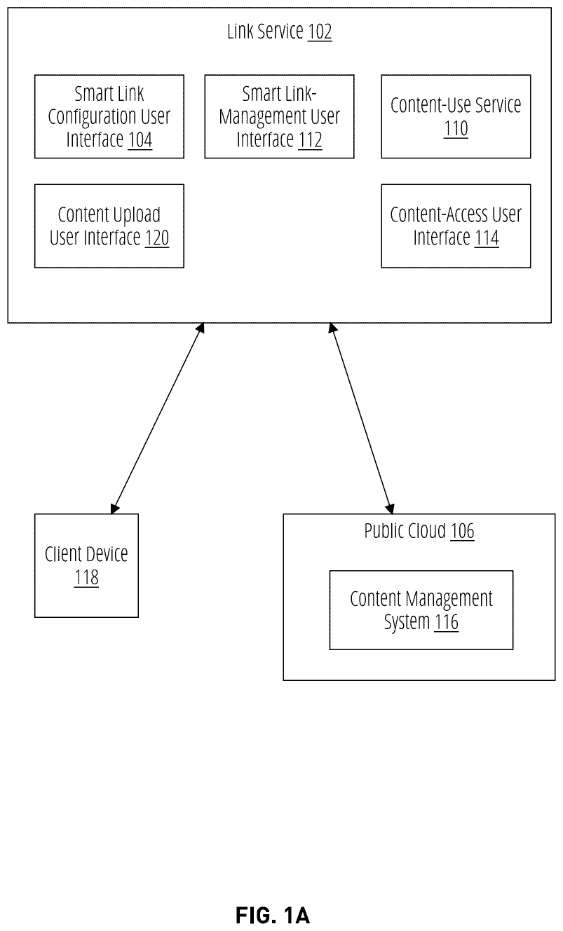

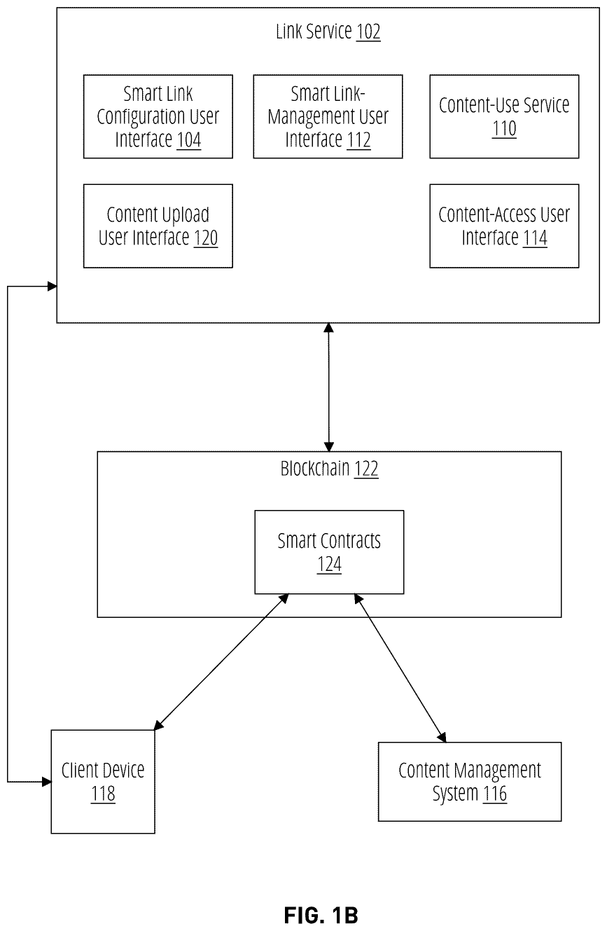

FIG. 1A illustrates an example system in which a link service facilitates the management, distribution, and controlled access of content stored in a public cloud in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

The increasing complexity of content sharing on the Internet has created significant challenges for rights holders, who struggle to maintain control over how their content is accessed, used, and modified once it is made available online. Traditional methods for managing digital rights often lack the flexibility and efficiency needed to prevent unauthorized use, enforce licensing terms, or track content distribution. The present system addresses these shortcomings by providing a link service 102 that allows rights holders to configure and enforce policy terms while offering a streamlined mechanism for users to access content under defined conditions.

As shown in FIG. 1A, the link service 102 includes multiple components that work together to enable content management and policy enforcement. A smart link configuration user interface 104 allows rights holders to configure content licenses, define policy terms, and establish conditions for how content may be accessed, used, or distributed. This interface ensures that content is associated with structured policy terms, which may be embodied in both human-readable and machine-readable formats to enable automated enforcement.

A smart link-management user interface 112 provides rights holders with a centralized tool to manage existing “smart links,” revoke or modify access rights, monitor content usage, and track interactions with the content. Through this interface, rights holders can enforce licensing terms dynamically, even after content has been shared.

To support content distribution, a content-use service 110 facilitates access to digital assets by enabling users to discover, view, and interact with content under agreed-upon policy terms. This service may also include mechanisms for requesting additional rights or negotiating custom licensing agreements with the rights holder.

A content-access user interface 114 ensures that content is presented to end users according to the defined policy terms, enforcing usage restrictions such as read-only access, watermarking, attribution requirements, or password-protected content access. This interface further allows rights holders to control the visibility and availability of their content without relying solely on public cloud infrastructure.

The system also incorporates a content upload user interface 120 that enables rights holders to upload content directly into the link service 102. When content is uploaded, policy terms and access control rules can be associated with the content, ensuring that licensing conditions are embedded at the metadata level. This process simplifies digital rights management and eliminates the need for rights holders to manually enforce licensing agreements after content has been distributed.

Once uploaded, content is stored in a content management system 116 within a public cloud 106, where it remains accessible under the governance of the link service 102.

The present system addresses a critical gap in content management by providing rights holders with a comprehensive framework for controlling content access, monitoring content distribution, and ensuring compliance with licensing terms. By integrating configurable smart links, automated policy enforcement, and dynamic access management, the link service 102 provides a scalable solution for digital rights holders seeking to maintain control over their intellectual property in an increasingly fragmented and unauthorized content-sharing environment.

FIG. 1B illustrates another example system in which a link service facilitates the management, distribution, and controlled access of content stored in a public cloud in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

FIG. 1B shares substantial overlap with the system addressed in FIG. 1A, except that the system in FIG. 1B takes advantage of a blockchain 122 and smart contracts 124. More specifically, link service 102 can provide a layer to allow a rights holder to interact with blockchain 122 and content management system 116. For example, the rights holder can interact with interfaces provided by link service 102 to configure license terms and a link. But instead of the link pointing to the link service 102, the link could point to blockchain 122 and smart contracts 124, which can determine if access is permitted via the terms associated with the license (embodied as a smart contract) in the link.

When access is granted to content, the content can be viewed or edited in content-use service 110, which as addressed herein, can be an interface provided by link service 102 or a third party application that is configured to respect the terms of the license. In the context of blockchain 122, content-use service 110 would be an application configured for use with blockchain 122 can that would use the content in a manner that is defined and controlled by smart contracts 124.

In FIG. 1B, content management system 116 could be part of a public cloud, or could be on-chain content management system 116. In some embodiments, content management system 116 might still record policy terms in metadata of the content item, or it might rely on smart contracts 124 to perform those functions.

Throughout this description, reference will be made to the system as illustrated in FIG. 1A for simplicity of explanation, but it should be understood by those of ordinary skill in the art that the methods and interfaces addressed herein could just as easily be addressed with respect to FIG. 1B and such implementations are explicitly contemplated as part of the present technology described herein.

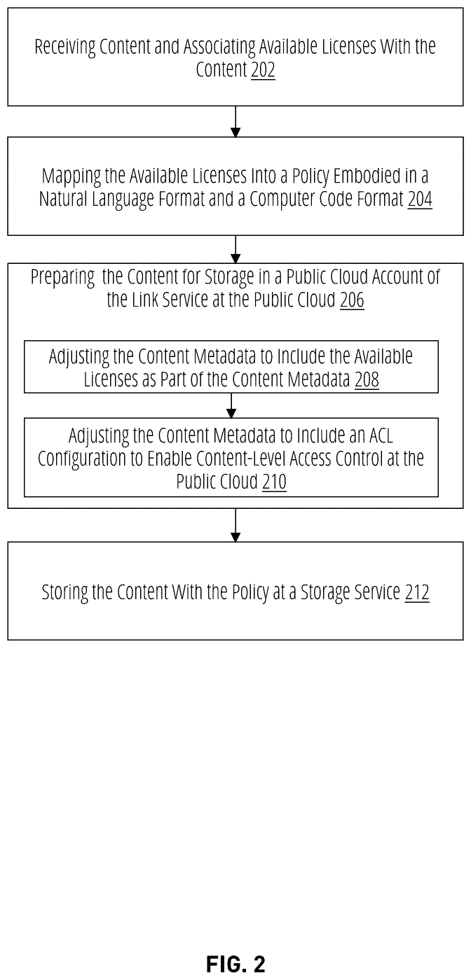

FIG. 2 illustrates an example routine for configuring content for management by the link service and for storing the content in a public cloud in a way that permits public user access to the content while managing the access and use of the content by the link service in accordance with some embodiments of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

In particular, FIG. 2 pertains to providing content for link service 102 to manage consistent with embodiments addressed herein.

According to some examples, the method includes receiving content and configuring available licenses for the content at block 202. For example, the link service 102 illustrated in FIG. 1A may receive the content and the available licenses from a rights holder.

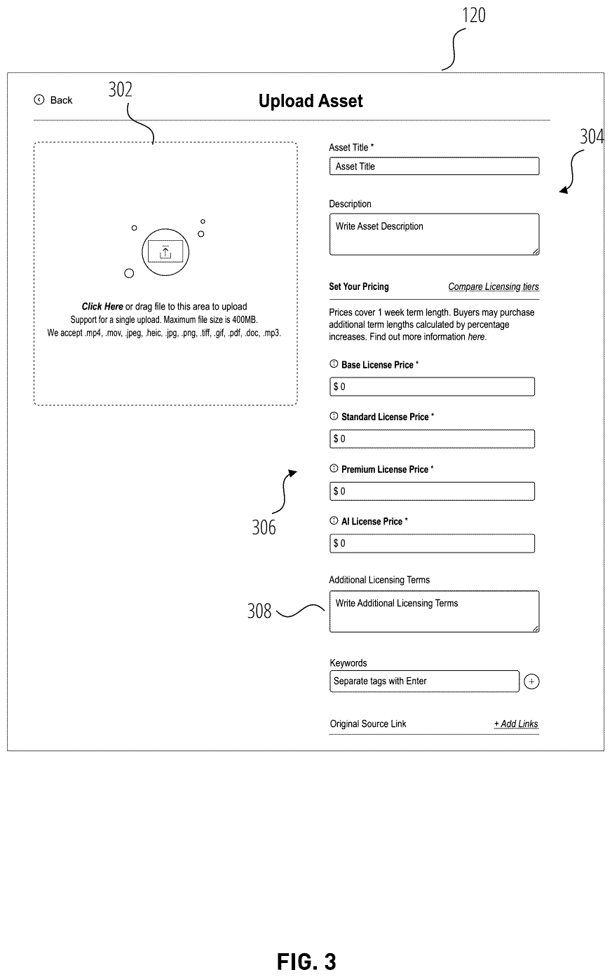

FIG. 3 illustrates an example user interface to receive content to be associated with the available licenses in accordance with some embodiments of the present technology. While FIG. 3 illustrates a particular user interface, the present technology should not be considered limited to use with such an interface. Rather the user interface illustrated in FIG. 3 is provided to illustrate example options and example functionality provided by the present technology.

FIG. 3 illustrates a content upload user interface 120, which includes content upload tool 302 to upload the content and descriptive fields 304 to provide a name to the content and a description of the content, if desired.

It is not necessary to upload content to take advantage of the present technology. As will be addressed with respect to other user interfaces, it is also possible to associate a link to content stored elsewhere with the at least one policy term and gain most of the benefits of the present technology.

Content upload user interface 120 also includes license pricing fields 306. Content upload user interface 120 includes fields for standard licenses or license tiers that can be associated with the content. License pricing fields 306 pertain to standard licenses offered by link service 102. A rights holder does not need to offer the content using all of these licenses. A selection of specific licenses to be used when sharing the content can be selected at a later time when creating specific links. Instead, content upload user interface 120 provides an opportunity to provide general license prices for these standard licenses. The rights holder can also add custom license terms using additional license terms field 308.

FIG. 3 shows several pre-configured versions of available licenses. The “Base License” is configured for the reposting of content. The “Standard License” is configured for reposting with minimal edits. The “Premium License” is configured for website and advertisement use. The “AI License” is configured for authorizing artificial intelligence tools to access and train on the content.

The licenses are both legal licenses written in natural language format and they are written in a computer code format, such as a JSON file. The computer code format enables the system to take programmatic actions when a new license is issued. For example, when a new license is issued, and as will be addressed herein, a smart link will be issued that needs to be configured with the appropriate access configurations, or when a license permits modifying content, the programmatic version of the license terms enable the content to be copied, and configure policies on the copy of the content as well as configure policies associated with the smart link. Thus, while the license is a legal document on one hand, it is also computer code with logic that interacts with both the permissions system of the content management system 116, and the link service 102.

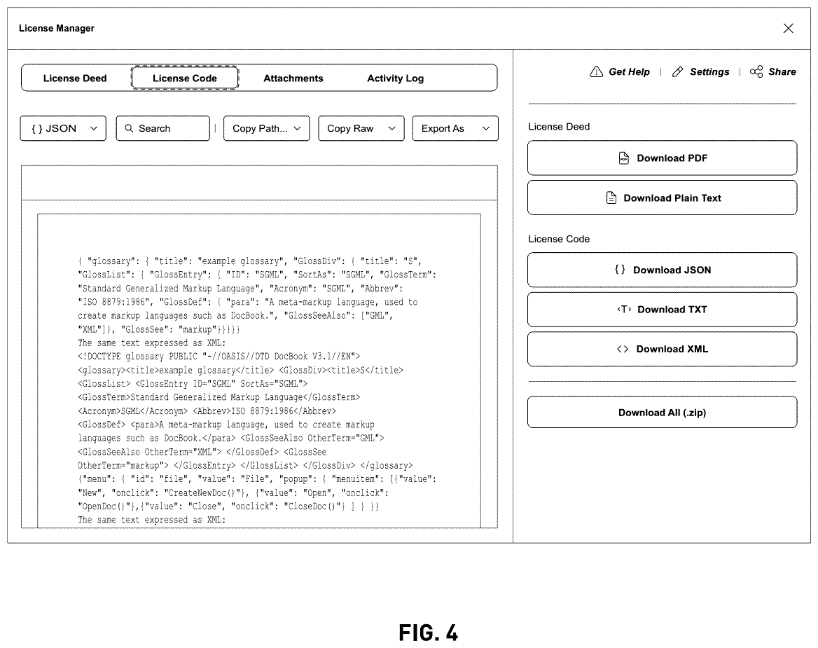

FIG. 4 illustrates an example of a license manager that shows a portion of a license embodied in computer code format in accordance with some embodiments of the present technology. While FIG. 4 illustrates a particular user interface, the present technology should not be considered limited to use with such an interface. Rather the user interface illustrated in FIG. 4 is provided to illustrate example options and example functionality provided by the present technology.

The license is longer than can be easily illustrated in FIG. 4, but it can include terms that would define, for example, if a standard license is selected, then read-only permissions are granted, and define a term when the read-only permissions expire. These terms can be used to generate access policies within the content management system and at the link service.

According to some examples, the method includes preparing the content for storage in a public cloud account of the link service at the public cloud at block 206. For example, the link service 102 illustrated in FIG. 1A may prepare the content for storage in a public cloud account of the link service at the public cloud. Storing content in a public cloud for the use case addressed herein is not straight forward. In most cases, storage at a public cloud such as AWS, AZURE, GOOGLE CLOUD, etc. stores content as part of an account such that the content can only be accessed by those that have credentials to access the content. While some content can be shared with those that don't have credentials to the account, this sharing is enabled by links provided by the public cloud. However, this access paradigm is not effective for the purposes of the present technology. In the present technology, links to content are issued by the link service 102 which can provide a layer for handling the content use scenarios described herein. The typical access permissions provided by a public cloud do not give a rights holder sufficient management and rights to copied and modified content. Additionally, working with the API schemes of public clouds is cumbersome and provides too much friction for the typical content reposting use case.

In some embodiments, the preparing of the content for storage in the public cloud account of the link service includes adjusting the metadata of the content as described with respect to block 208 and block 210.

According to some examples, the method includes adjusting the content metadata to include the available licenses as part of the content metadata at block 208. For example, the link service 102 illustrated in FIG. 1A may adjust the content metadata to include the available licenses as part of the content metadata. In this way, the available licenses are tightly coupled to the content. This can enable downstream users of the content to be able to review and purchase one of the available licenses to enable technical permissions and access to the content in accordance with the selected license.

In some embodiments, the policy is a smart contract, wherein the smart contract is a self-executing contract with the policy terms available for the content written into lines of code executable by the storage service storing the content. The storage service is a blockchain network or supported by a blockchain network.

According to some examples, the method also includes adjusting the content metadata to include an ACL configuration to enable content-level access control at the public cloud at block 210. For example, the link service 102 illustrated in FIG. 1A may adjust the content metadata to include an ACL configuration to enable content-level access control at the public cloud. Access to the content at the public cloud account of the link service is controlled by the ACL configuration. The ACL configuration is interpretable by the public cloud resources to permit persistent access to the content by parties that do not have access credentials to the public cloud account of the link service. The policy terms available for the content and the ACL configuration are modifiable by the link service.

According to some examples, the method includes storing the content with the policy at a storage service at block 212. For example, the link service 102 illustrated in FIG. 1A may store the content with the policy at a storage service. The policy controls at least the use of the content by a party accessing the content. The content is stored with the metadata pre-configured to enable desired access behaviors for the content at the public cloud.

The present technology can also embed policy information directly within the code or metadata of digital contents shared by a fully public link so that when the content is provided to an artificial intelligence (AI), the AI can enforce, interpret, and adhere to the policy terms set forth by the rights holders. This methodology ensures that the utilization of the content is executed precisely as intended by its rights holder, ranging from access permissions to restrictions on use, modification, and distribution. By integrating the policy into the content's code, the system enables AI to automatically recognize and understand the specified terms without the need for manual oversight or interpretation. This capability allows for real-time compliance and enforcement of policy conditions, thus significantly reducing the risk of unauthorized use or infringement of intellectual property rights. Moreover, this system is designed to facilitate a two-way communication channel between the content and its creators or rights holders. As AI applications interact with the content, they can collect and relay usage data back to the originators according to the preferences and requirements stipulated in the embedded policy. This could encompass information such as the frequency of content access, geographical locations of users, modification logs, or any other relevant analytics. Such feedback is invaluable for rights holders, offering deep insights into how their content is being utilized. This can inform future decisions related to content creation, distribution strategies, and intellectual property management. The embedded policy approach thus represents a forward-thinking solution that aligns with the evolving landscape of digital content management, ensuring creators maintain control and visibility over their intellectual property in an increasingly automated world.

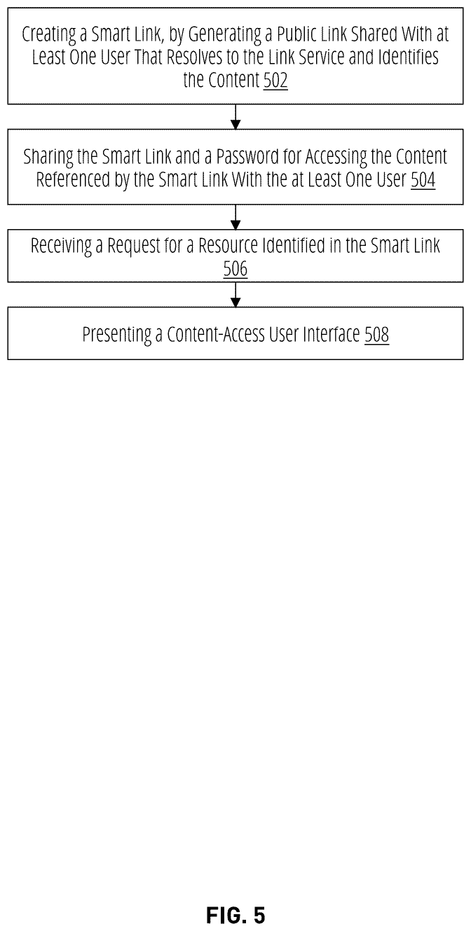

FIG. 5 illustrates an example routine for creating a smart link associated with the content and providing access to the content through the smart link in accordance with some embodiments of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

Storing the content in the public cloud with the available licenses configures the content for use with the link service 102, but does not make the content available to anyone other than the rights holder of the content. Therefore, when the rights holder wants to post the content online, say through a social media platform or blog post, the rights holder should first create a smart link to the content. A “smart link” is a link that points to a link service and that identifies content that is accessible via the smart link and is generally associated with one or more access or use policies for the content accessible via the smart link. Another attribute of the smart link is that it remains manageable throughout it existence, as will be addressed further herein. In some embodiments, the smart link is password protected to ensure that only authorized parties can access the content through the link service. The link service can decide whether the link caller should be given access to the content. Due to this infrastructure, a smart link can be revoked by a rights holder such that the link service will no longer provide access to the content when the smart link is called. Likewise, the rights holder can modify conditions upon which a caller of a valid smart link can access or use content. Further details about smart links and functions made available by smart links are addressed herein

According to some examples, the method includes creating a smart link by generating a public link shared with at least one user at block 502. For example, the link service 102 illustrated in FIG. 1A may create a smart link by generating a public link shared with at least one user that resolves to the link service and identifies the content. In some embodiments, the smart link can be password protected.

The link service 102 also interacts with the content management system to modify the content metadata of the content to reference the smart link and the agreed policy terms. While in the social media post example, the smart link was being generated for use by the rights holder, but in other examples, the smart link can be generated by the rights holder to give rights to a third party under a license. In such examples, the smart link is specific to the license. The metadata of the content can be edited to reflect the smart link and the license associated with that particular smart link.

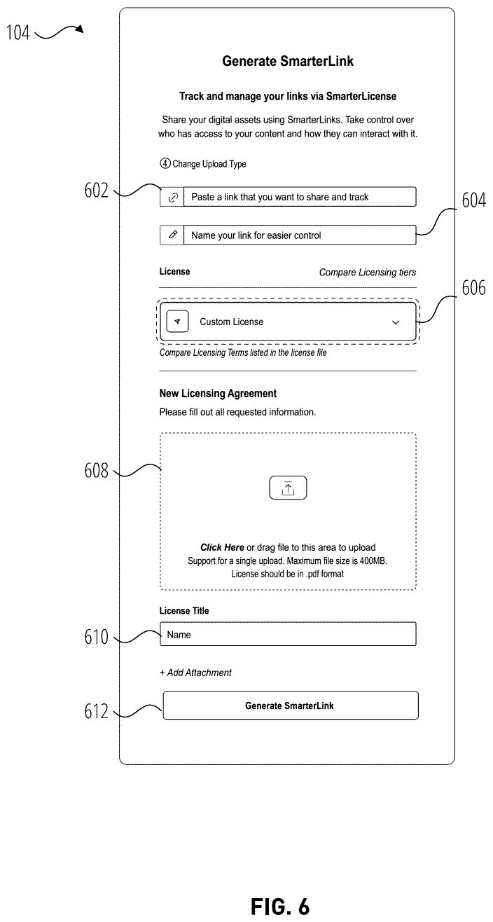

FIG. 6 illustrates an example smart link configuration user interface in accordance with some embodiments of the present technology. While FIG. 6 illustrates a particular user interface, the present technology should not be considered limited to use with such an interface. Rather the user interface illustrated in FIG. 6 is provided to illustrate example options and example functionality provided by the present technology.

The rights holder can identify the content through a link to the content in a public cloud. In some embodiments, the public cloud hosts the public cloud account of the link service. However, in some embodiments, a rights holder could create a smart link to any content stored at a link that is persistently accessible via the provided link.

The rights holder identifies the content by providing a link to the content in content location in content storage field 602. The rights holder can also give a name to the smart link being created in the link name field 604.

The rights holder can further associate the smart link with a particular license selected from existing license selector 606. For example, the rights holder might choose the “Base License” “Standard License”, “Premium License”, “AI License”, other previously defined license, or “Custom License.” FIG. 6 illustrates a selection of the custom license option, which permits the user to upload and define a new license by uploading the license terms in the custom license upload field 608, and naming the license in the license title field 610.

When the rights holder uploads a custom license, the link service 102 can analyze the license to transform the license into a code format and extract key terms that can be codified by link service. In some embodiments, this can be performed by a generative AI tool. The license terms are then stored as part of the content metadata.

Finally, the rights holder can select the generate link button 612 to create the smart link.

Continuing with the example where the rights holder wants to publish content in a social media feed, the rights holder can interact with the link service to create a public link that authorizes a web browser to receive a read-only copy of the content for rendering in the social media feed. In this example, the smart link may or may not require a password in order to access the content.

According to some examples, the method includes sharing the smart link for accessing the content referenced by the smart link with the at least one user or platform (such as a social media feed) at block 504. For example, the link service 102 illustrated in FIG. 1A may share the smart link for accessing the content referenced by the smart link with at least one user or platform.

Again returning to the example of the rights holder publishing their content via their social media feed, the rights holder can publish their content by embedding the smart link in their social media feed. In some embodiments, the smart link can be to a preview image version of the content and can be embedded in an iFrame that is rendered from the link service itself.

Other types of sharing of the content exist. For example, the rights holder might want to share their content with a specific user or publisher. In such an example, the rights holder might want to allow greater access than read-only access, or the rights holder might want to protect the access to the content to only users who have a password-the link can be associated with a password prior to allowing access to the content.

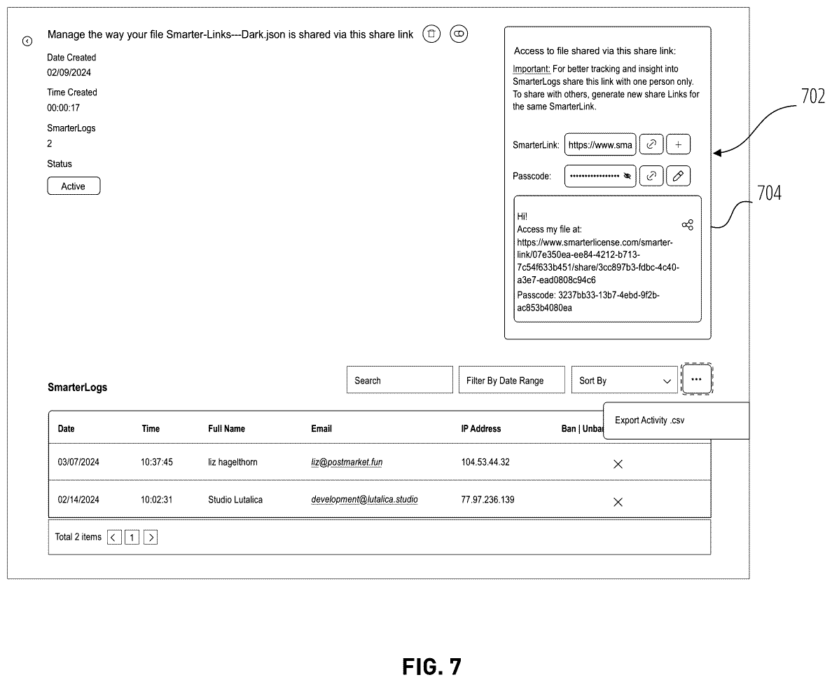

FIG. 7 illustrates an example of a smart link-management user interface 112 for managing smart links of the content by the rights holder, and for viewing data pertaining to access of the content by the smart links in accordance with some embodiments of the present technology. While FIG. 7 illustrates a particular user interface, the present technology should not be considered limited to use with such an interface. Rather the user interface illustrated in FIG. 7 is provided to illustrate example options and example functionality provided by the present technology.

FIG. 7 illustrates smart link fields 702 which display the link address and password to the smart link. Additionally, the rights holder can share the smart link using sharing button 704.

According to some examples, the method includes receiving a request for a resource identified in the smart link at block 506. For example, the link service 102 illustrated in FIG. 1A may receive a request for a resource identified in the smart link. The request is the result of at least one user calling the smart link. The link service 102 can perform a variety of link service related features, such as confirming that the link is valid, that the link caller is valid, that the referring webpage is a valid website for displaying the content, handling link logging, and other protections and services common when links are called.

According to some examples, the method includes presenting a content-access user interface at block 508. For example, the link service 102 illustrated in FIG. 1A may presenting a content-access user interface 114. The content-access user interface 114 can present the content according to the agreed policy terms. In some embodiments, the calling user may need to enter the password associated with the smart link before the content is presented in the content-access user interface 114.

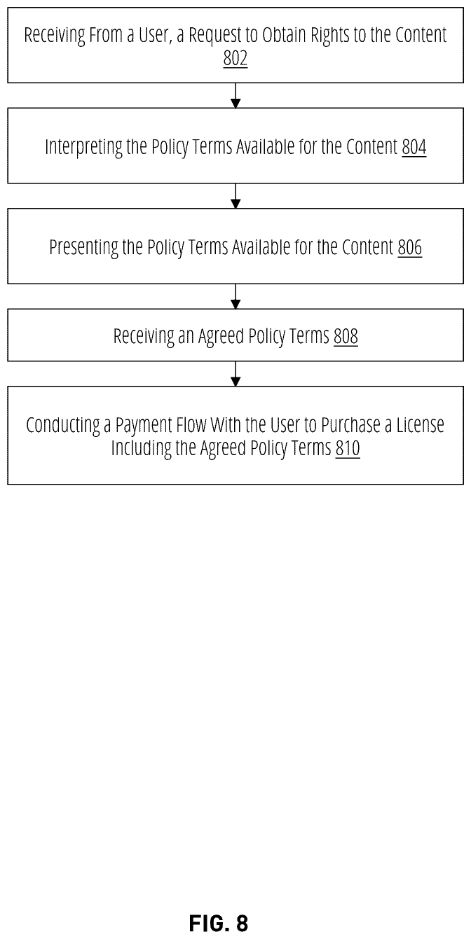

FIG. 8 illustrates an example routine for facilitating acceptance and/or negotiation of policy terms and for obtaining access to the content under the agreed policy terms in accordance with some embodiments of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

A benefit of the present technology is to enable users to find content online and request permission to use the content for their own purposes while acting within the scope of permission granted from a rights holder. The methods described above configure content with terms that can be accepted and agreed upon between the rights holder and a user wishing to obtain further rights to the content in an efficient manner.

According to some examples, the method includes receiving from a user, a request to obtain rights to the content at block 802. For example, the link service 102 illustrated in FIG. 1A may receive from a user, a request to obtain rights to the content. For example, when a user finds the content online, the user might click on the smart link, which can bring the user to a page at the link service.

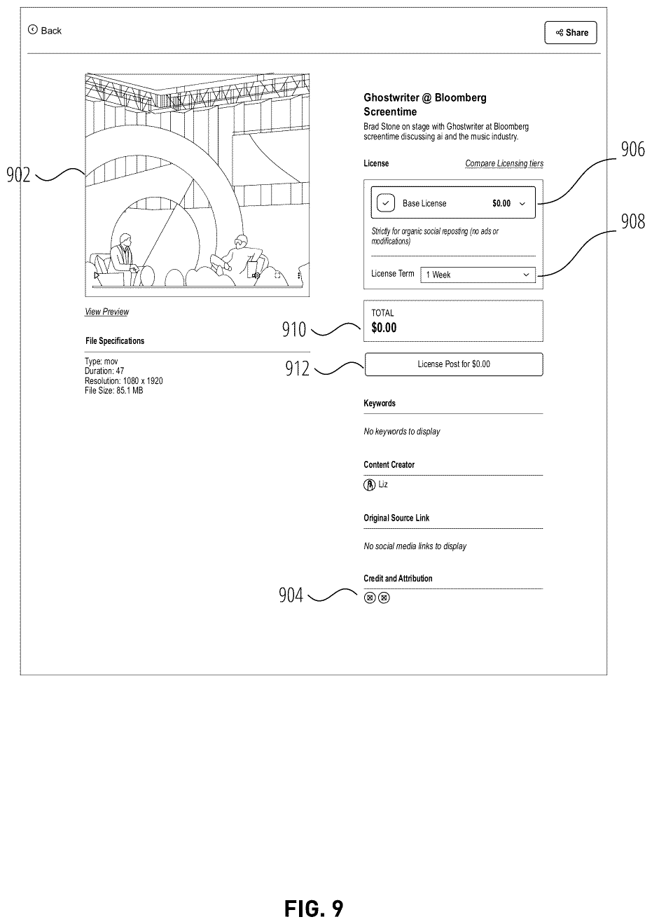

FIG. 9 illustrates an example content-use service 110 for selecting policy terms and/or negotiating custom terms for the content in accordance with some embodiments of the present technology. While FIG. 9 illustrates a particular user interface, the present technology should not be considered limited to use with such an interface. Rather the user interface illustrated in FIG. 9 is provided to illustrate example options and example functionality provided by the present technology.

FIG. 9 illustrates a content-use service 110 for content shown in content thumbnail 902.

According to some examples, the method includes interpreting the policy terms available for the content at block 804. For example, the link service 102 illustrated in FIG. 1A may interpret the policy terms available for the content by interpreting the meta data associated with the content to determine available licenses.

According to some examples, the method includes presenting the policy terms available for the content at block 806. For example, link service 102, illustrated in FIG. 1, may present the policy terms available for the content in content-use service 110. In some embodiments, such as illustrated in FIG. 9, the user can interact with the content-use service 110 to view available licenses and the cost for licenses. For example, the user can insert with license selector menu 906 and term selector menu 908 to select the desired license and the term for the license. The user can also review all the policy terms in detail by clicking on an option in the UI to view the full license (e.g., compare license tiers link). In some embodiments, the content can also require certain attribution to the content creator or rights holder, shown in attribution information 904.

According to some examples, the method includes receiving agreed policy terms at block 808. For example, the link service 102 illustrated in FIG. 1A may receive agreed policy terms. The agreed policy terms can include at least one policy term and/or include a custom-negotiated licensing term.

While not shown in FIG. 9, the user that desires a license might wish to negotiate different terms than the standard terms in the available licenses. The link service 102 can support such negotiations by coordinating messages between the parties. Ultimately, one of the parties can provide a custom license to which the other party can agree or reject.

According to some examples, the method includes conducting a payment flow with the user to purchase a license, including the agreed policy terms at block 810. For example, the link service 102 illustrated in FIG. 1A may conduct a payment flow with the user to purchase a license including the agreed policy terms. For example, FIG. 9 illustrates cost 910 of license and purchase license button 912, which, when selected, can initiate the payment flow.

The present technology can also facilitate a streamlined process for handling bulk payment transactions wherein a buyer accumulates various items or services, represented by Stock Keeping Units (SKUs), into a single cart. Upon making a singular payment for the collective items in the cart, the innovative system of Smart links generates an obligation to disburse payments corresponding to each SKU to their respective rights holders. This is significant because it enables the efficient and accurate allocation of payments to multiple rights holders from a single transaction initiated by the buyer. A unique aspect of the system is its capability to initiate and maintain an obligation to pay rights holders who may not yet have completed the setup of a traditional bank account or who do not currently satisfy all prerequisites for receiving payments. The system securely holds the obligation and ensures that, once the rights holder meets the necessary conditions for payment-which may include account setup, identity verification, or any other specified requirements-the payment is automatically processed and disbursed without delay. This mechanism ensures that rights holders are guaranteed compensation for their goods or services sold through Smart links, even in cases where immediate payment is not possible due to logistical or administrative reasons. The system thus provides a reliable and efficient method for managing payments in transactions involving multiple stakeholders, reducing administrative overhead and improving the ease of conducting business for all parties involved.

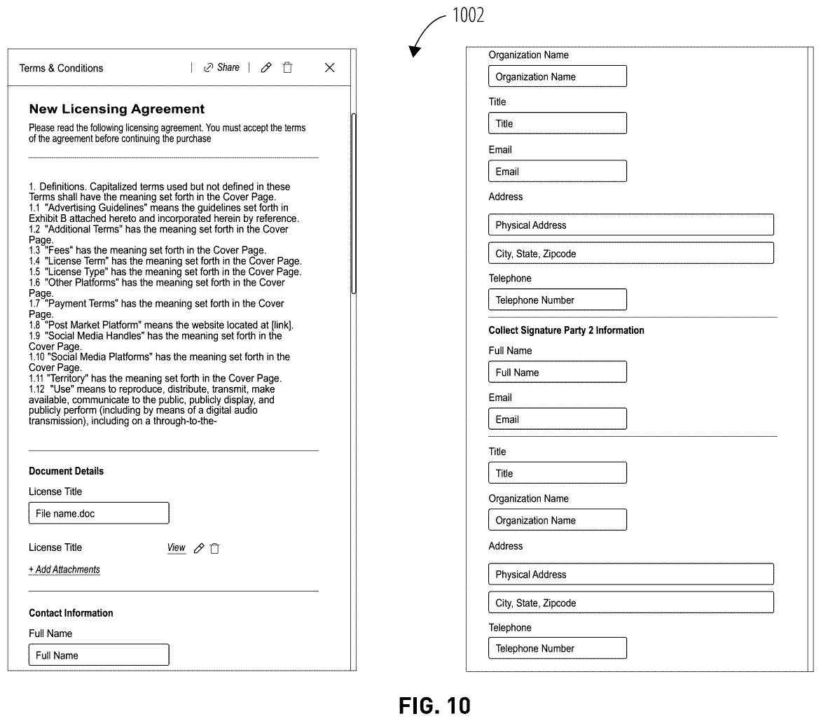

FIG. 10 illustrates an example license form 1002 in accordance with some embodiments of the present technology. In FIG. 10, license form 1002 is broken into two parts, but it can make up a single scrollable form.

License form 1002 is another example of an interface in which the user wishing to obtain rights to the content can review the license terms. Additionally, the user interacts with license form 1002 to execute the license by completing the blank fields.

After the user has executed the license form 1002 and completed the payment flow, the user can receive a smart link specific to their agreement with the rights holder.

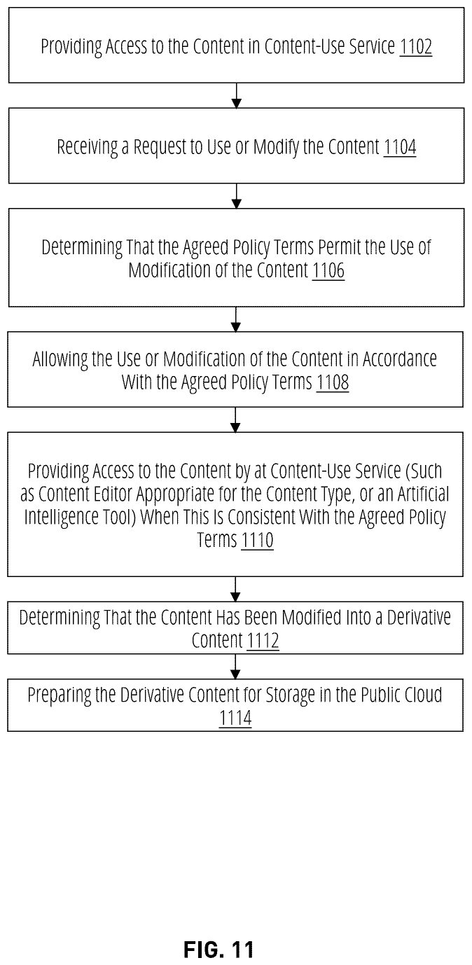

FIG. 11 illustrates an example routine for providing access to the content and permitting uses of the content that are permitted by the agreed policy terms in accordance with some embodiments of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

Not only does the present technology enable users to obtain content with permission from the rights holder, but the present technology can also ensure that the content is used in a manner consistent with the agreed policy terms.

According to some examples, the method includes providing access to the content in content-use service at block 1102. For example, the link service 102 illustrated in FIG. 1A may provide access to the content in the content-use service. In some embodiments, the user can interact with the smart link that was issued to them as part of the license, which requests access to the content from link service 102.

The content-use service can be any application that is configured to display the content, provided that the content-use service will respect the terms of the license. In this respect, the content-use service can be an interface provided by the link service 102, that might allow viewing, editing, or copying of the content. Of course, much content is generated using powerful, specific purpose tools, and these tools can also be used to view, edit, or copy the content, when these tools have an integration with link service 102.

In some embodiments, the license might only permit view-only access. In such embodiments, the content might be rendered in a view provided by the link service 102, wherein the content-access user interface 114 is rendered via an iFrame in another webpage or application.

According to some examples, the method includes receiving a request to use or modify the content at block 1104. For example, the link service 102 illustrated in FIG. 1A may receive a request to use or modify the content.

According to some examples, the method includes determining that the agreed policy terms permit the use or modification of the content at block 1106. For example, the link service 102 illustrated in FIG. 1A may determine that the agreed policy terms permit the use or modification of the content.

According to some examples, the method includes allowing the use or modification of the content in accordance with the agreed policy terms at block 1108. For example, the link service 102 illustrated in FIG. 1A may allow the use or modification of the content in accordance with the agreed policy terms.

In embodiments, where the license permits the content to be modified, the link service 102 can interact with content management system 116 to first make a copy of the content and embed the appropriate license terms and restrictions in the metadata of the copy of the content.

The types of tools that can be used to modify content can also be restricted. For example, some rights holders might not want their content to be accessible by an artificial intelligence tool. This might be especially important for influencers that might put pictures of themselves on the Internet. Such influencers would not want AI tools that create “deepfakes” to be allowed to change the appearance or context of the image or influencer. Thus, such tools might not be able to access the content. Additionally, reputable AI tools will receive the license terms as part of the metadata of the content and will respect the terms of the license.

According to some examples, the method includes providing access to the content by the content-use service (such as content editor appropriate for the content type, or an artificial intelligence tool) when this is consistent with the agreed policy terms at block 1110. For example, the link service 102 illustrated in FIG. 1A may provide access to the content by a content-use service. In some embodiments, this includes rendering the content in a web interface provided by the link service or allowing the content to be opened by an application that is configured to interact with the link service to respect the license terms.

According to some examples, the method includes determining that the content has been modified into derivative content at block 1112. For example, the link service 102 illustrated in FIG. 1A may determine that the content has been modified into the derivative content. In such embodiments, it is important that any terms or attributions associated with the content that are relevant to the derivative content are copied into the content metadata and that derivative content is stored and maintained by the link service. Only content for which a license term gives a license holder rights to copy content without restriction should be permitted to be downloaded for storage outside of link service 102.

According to some examples, the method includes preparing the derivative content for storage in the public cloud at block 1114. For example, the link service 102 illustrated in FIG. 1A may prepare the derivative content for storage in the public cloud. The metadata of the derivative content refers to the content and the agreed policy terms, whereby future use of the derivative content is controlled by the agreed policy terms.

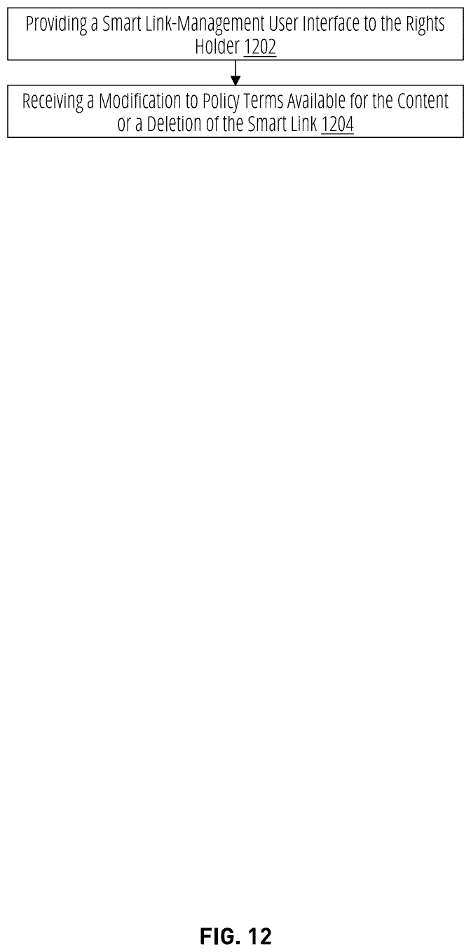

FIG. 12 illustrates an example routine for providing a smart link-management user interface and for managing access to the content and derivatives of the content in accordance with some embodiments of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

Traditional systems do not allow content creators control to ensure that their works are used in the way(s) in which their work is intended. The present technology addresses this by providing a smart link-management user interface to allow rights holders to manage access and the use of their content and some derivatives of their content. While the link service 102 is effective in limiting many uses of the content to the agreed policy terms associated with the content and the particular smart link, it can still be possible for content to be used in ways the rights holder does not intend.

According to some examples, the method includes providing a smart link-management user interface to the rights holder at block 1202. The smart link-management user interface 112 displays content and the derivative content controlled by the rights holder.

According to some examples, the method includes receiving a modification to policy terms available for the content or a deletion of the smart link at block 1204. The modification is applied to further attempts to access the content.

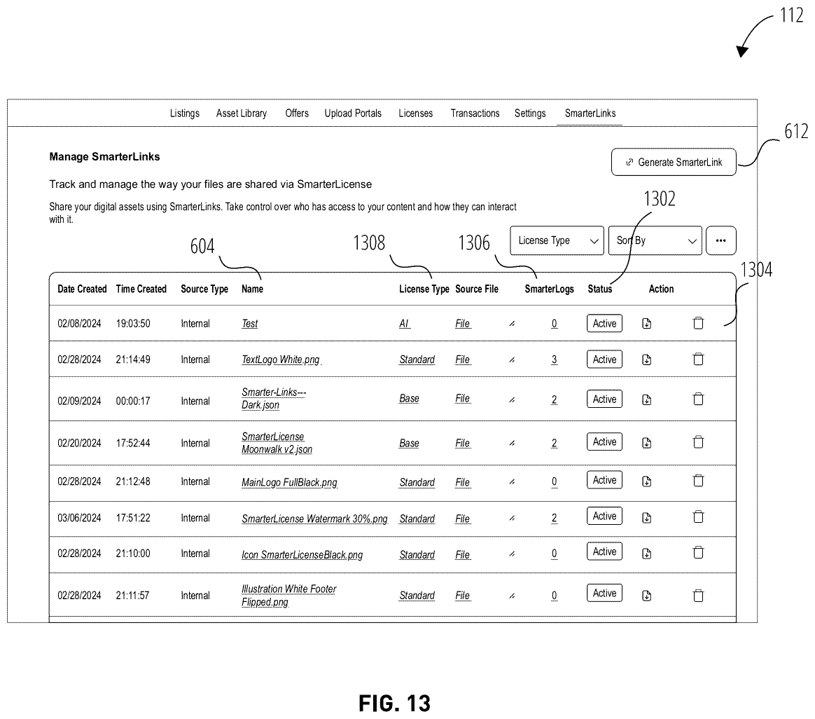

FIG. 13 illustrates an example of a smart link-management user interface for managing smart links of content by the rights holder in accordance with some embodiments of the present technology.

For example, FIG. 13 displays smart link-management user interface 112, which lists all smart links managed by the rights holder. One way of identifying particular links is through the link name field 604. As addressed above, multiple smart links can be issued for the same content. A respective smart link is associated with a link to the content 1308, and the rights holder can easily see the current status of the smart link under license status 1302. A smart link can be active, suspended, revoked, expired, etc.

A rights holder can also view access logs 1306 which can show display a log file showing IP address of those that accessed the content, and any referring webpages (such as when the content thumbnail is displayed on a webpage, and that webpage refers a user that clicks on the thumbnail to the address in the smart link). The log file can also show attempts to download the content and other actions and whether the requested actions succeeded or failed and why. Some actions will fail because they exceed the license terms.

A rights holder can also delete a smart link by selecting the respective icon under the delete link 1304 column. This gives the rights holder the ultimate control over the use of their content. They can revoke access at anytime.

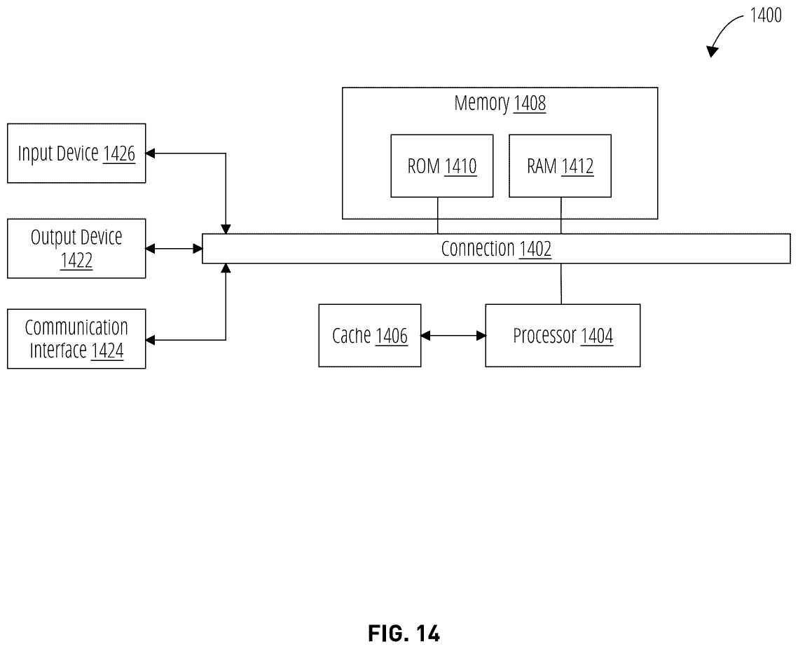

FIG. 14 shows an example of computing system 1400, which can be, For example, any computing device making up any service, system, or device illustrated in FIG. 1A or any component thereof.

In some embodiments, computing system 1400 is a single device, or a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

In some embodiments, computing system 1400 may comprise one or more computing resources provisioned from a “cloud computing” provider, For example, AMAZON ELASTIC COMPUTE CLOUD (“AMAZON EC2”), provided by AMAZON, INC. of Seattle, Washington; SUN CLOUD COMPUTER UTILITY, provided by SUN MICROSYSTEMS, INC. of Santa Clara, California; AZURE, provided by MICROSOFT CORPORATION of Redmond, Washington, GOOGLE CLOUD PLATFORM, provided by ALPHABET, INC. of Mountain View, California, and the like.

Example computing system 1400 includes at least one processing unit (CPU or processor) 1404 and connection 1402 that couples various system components including system memory 1408, such as read-only memory (ROM) 1410 and random access memory (RAM) 1412 to processor 1404. Memory 1408 can be a volatile or non-volatile memory device, and can be a hard disk or other types of non-transitory computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

Memory 1408 can include software services, servers, logic, etc., that when the code that defines such software is executed by the processor 1404, it causes the system to perform a function. In some embodiments, a hardware service that performs a particular function can include the software component stored in a computer-readable medium in connection with the necessary hardware components, such as processor 1404, connection 1402, output device 1422, etc., to carry out the function.

Computing system 1400 can include a cache of high-speed memory 1406 connected directly with, in close proximity to, or integrated as part of processor 1404.

Connection 1402 can be a physical connection via a bus, or a direct connection into processor 1404, such as in a chipset architecture. Connection 1402 can also be a virtual connection, networked connection, or logical connection.

Processor 1404 can include any general purpose processor and a hardware service or software service stored in memory 1408, configured to control processor 1404 as well as a special-purpose processor where software instructions are incorporated into the actual processor design. Processor 1404 may essentially be a completely self-contained computing system, containing multiple cores or processors, a bus, memory controller, cache, etc. A multi-core processor may be symmetric or asymmetric. Processor 1404 can be physical or virtual.

To enable user interaction, computing system 1400 includes an input device 1426, which can represent any number of input mechanisms, such as a microphone for speech, a touch-sensitive screen for gesture or graphical input, keyboard, mouse, motion input, speech, etc. Computing system 1400 can also include output device 1422, which can be one or more of a number of output mechanisms known to those of skill in the art. In some instances, multimodal systems can enable a user to provide multiple types of input/output to communicate with computing system 1400. Computing system 1400 can include communication interface 1424, which can generally govern and manage the user input and system output. There is no restriction on operating on any particular hardware arrangement, and therefore the basic features here may easily be substituted for improved hardware or firmware arrangements as they are developed.

In some embodiments, computing system 1400 can refer to a combination of a personal computing device interacting with components hosted in a data center, where both the computing device and the components in the data center. In such examples, both the personal computing device and the components in the datacenter might have a processor, cache, memory, storage, etc.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

### Aspects

The present technology includes computer-readable storage mediums for storing instructions, and systems for executing any one of the methods embodied in the instructions addressed in the aspects of the present technology presented below:

Aspect 1: A method comprising: receiving, by a link service, a content and policy terms available for the content including at least one policy term; mapping, by the link service, the policy terms available for the content into a policy embodied in a natural language format and a computer code format; and storing, by the link service, the content with the policy at a storage service, whereby the policy controls use of the content by a party accessing the content.

Aspect 2: The method of aspect 1, wherein the policy is a smart contract, wherein the smart contract is a self-executing contract with the policy terms available for the content written into lines of code executable by the storage service storing the content.

Aspect 3: The method of any one of aspects 1-2, wherein the storage service is supported by a blockchain network.

Aspect 4: The method of any one of aspects 1-3, wherein the storage service is a public cloud.

Aspect 5: The method any one of aspects 1-4, further comprising: preparing, by the link service, the content for storage in a public cloud account of the link service at the public cloud, the preparing the content for storage in the public cloud includes: adjusting metadata for the content to include the policy as part of the metadata, and adjusting the metadata to include an ACL configuration to enable content-level access control at the public cloud, wherein access to the content at the public cloud account of the link service is controlled by the ACL configuration, wherein the ACL configuration is interpretable by the public cloud to permit persistent access to the content by parties that do not have access credentials to the public cloud account of the link service, wherein the policy terms available for the content and the ACL configuration are modifiable by the link service.

Aspect 6: The method any one of aspects 1-5, wherein the content is stored with the metadata pre-configured to enable desired access behaviors for the content at the public cloud.

Aspect 7: The method any one of aspects 1-6, further comprising: receiving, by the link service, from a user, a request to obtain rights to the content; interpreting, by the link service, the policy terms available for the content; presenting, by the link service, the policy terms available for the content; receiving, by the link service, an agreed policy terms, wherein the agreed policy terms can include the at least one policy term and/or include a custom negotiated policy term; conducting, by the link service, a payment flow with the user to purchase a policy including the agreed policy terms;

Aspect 8: The method any one of aspects 1-7, further comprising: creating, by the link service, a smart link, by generating a password protected public link shared with at least one user that resolves to the link service and identifies the content, and by modifying metadata of the content to reference the smart link and the agreed policy terms, sharing, by the link service, the smart link and a password for accessing the content referenced by the smarterlink with the at least one user; receiving, by the link service, a request for a resource identified in the smart link, wherein the request is the result of the at least one user calling the smart link; presenting, by the link service, a content-access user interface, the content-access user interface providing a password input field, the content-access user interface presenting the agreed policy terms; receiving, in the content-access user interface of the link service, the password to access the content identified by the smart link.

Aspect 9: The method any one of aspects 1-8, further comprising: providing, by the link service, access to the content in content-use service; receiving, by the link service, a request to use or modify the content; determining, by the link service, that the agreed policy terms permit the use of modification of the content; and allowing the use or modification of the content in accordance with the agreed policy terms.

Aspect 10: The method any one of aspects 1-9, further comprising: providing access to the content by at content modification service when this is consistent with the agreed policy terms; determining that the content has been modified into a derivative content; preparing the derivative content for storage in the public cloud, wherein the metadata of the refers to the content and the agreed policy terms, whereby future use of the derivative content is controlled by the agreed policy terms.

Aspect 11: The method any one of aspects 1-10, further comprising: providing a smart link-management user interface to the rights holder, wherein the smart link-management user interface displays contents including the content and the derivative content controlled by the rights holder; receiving a modification to policy terms available for the content or a deletion of the smart link, whereby the modification is applied to further attempts to access the content.

What is claimed is:

1. A method comprising:
receiving, by a link service, a content and policy terms available for the content including at least one policy term;
mapping, by the link service, the policy terms available for the content into a policy embodied in a natural language format and a computer code format; and
storing, by the link service, the content with the policy at a storage service, whereby the policy controls use of the content by a party accessing the content.

2. The method of claim 1, wherein the policy is a smart contract, wherein the smart contract is a self-executing contract with the policy terms available for the content written into lines of code executable by the storage service storing the content.

3. The method of claim 1, further comprising:
preparing, by the link service, the content for storage in a public cloud account of the link service at the public cloud, the preparing the content for storage in the public cloud includes:
adjusting metadata for the content to include the policy as part of the metadata, and
adjusting the metadata to include an ACL configuration to enable content-level access control at the public cloud, wherein access to the content at the public cloud account of the link service is controlled by the ACL configuration, wherein the ACL configuration is interpretable by the public cloud to permit persistent access to the content by parties that do not have access credentials to the public cloud account of the link service, wherein the policy terms available for the content and the ACL configuration are modifiable by the link service.

4. The method of claim 1, further comprising:
receiving, by the link service, from a user, a request to obtain rights to the content;
interpreting, by the link service, the policy terms available for the content;
presenting, by the link service, the policy terms available for the content;
receiving, by the link service, an agreed policy terms, wherein the agreed policy terms can include the at least one policy term and/or include a custom negotiated policy term;
conducting, by the link service, a payment flow with the user to purchase a policy including the agreed policy terms.

5. The method of claim 4, further comprising:
creating, by the link service, a smart link, by generating a password protected public link shared with at least one user that resolves to the link service and identifies the content, and by modifying metadata of the content to reference the smart link and the agreed policy terms,
sharing, by the link service, the smart link and a password for accessing the content referenced by the smarterlink with the at least one user;
receiving, by the link service, a request for a resource identified in the smart link, wherein the request is the result of the at least one user calling the smart link;
presenting, by the link service, a content-access user interface, the content-access user interface providing a password input field, the content-access user interface presenting the agreed policy terms;
receiving, in the content-access user interface of the link service, the password to access the content identified by the smart link.

6. The method of claim 5, further comprising:
providing, by the link service, access to the content in content-use service;
receiving, by the link service, a request to use or modify the content;
determining, by the link service, that the agreed policy terms permit the use of modification of the content; and
allowing the use or modification of the content in accordance with the agreed policy terms.

7. The method of claim 6, further comprising:
providing access to the content by at content modification service when this is consistent with the agreed policy terms;
determining that the content has been modified into a derivative content;
preparing the derivative content for storage in the public cloud, wherein the metadata of the refers to the content and the agreed policy terms, whereby future use of the derivative content is controlled by the agreed policy terms.

8. The method of claim 7, further comprising:
providing a smart link-management user interface to the rights holder, wherein the smart link-management user interface displays contents including the content and the derivative content controlled by the rights holder;
receiving a modification to policy terms available for the content or a deletion of the smart link, whereby the modification is applied to further attempts to access the content.

9. A computing system comprising:
at least one processor; and
a memory storing instructions that, when executed by the at least one processor, configure the computing system to:
receive, by a link service, a content and policy terms available for the content including at least one policy term;
map, by the link service, the policy terms available for the content into a policy embodied in a natural language format and a computer code format; and
store, by the link service, the content with the policy at a storage service, whereby the policy controls use of the content by a party accessing the content.

10. The computing system of claim 9, wherein the policy is a smart contract, wherein the smart contract is a self-executing contract with the policy terms available for the content written into lines of code executable by the storage service store the content.

11. The computing system of claim 9, wherein the instructions further configure the computing system to:
prepare, by the link service, the content for storage in a public cloud account of the link service at the public cloud, the preparing the content for storage in the public cloud includes:
adjust metadata for the content to include the policy as part of the metadata, and
adjust the metadata to include an ACL configuration to enable content-level access control at the public cloud, wherein access to the content at the public cloud account of the link service is controlled by the ACL configuration, wherein the ACL configuration is interpretable by the public cloud to permit persistent access to the content by parties that do not have access credentials to the public cloud account of the link service, wherein the policy terms available for the content and the ACL configuration are modifiable by the link service.

12. The computing system of claim 9, wherein the instructions further configure the computing system to:
receive, by the link service, from a user, a request to obtain rights to the content;
interpret, by the link service, the policy terms available for the content;
present, by the link service, the policy terms available for the content;
receive, by the link service, an agreed policy terms, wherein the agreed policy terms can include the at least one policy term and/or include a custom negotiated policy term;
conduct, by the link service, a payment flow with the user to purchase a policy including the agreed policy terms.

13. The computing system of claim 12, wherein the instructions further configure the computing system to:
create, by the link service, a smart link, by generating a password protected public link shared with at least one user that resolves to the link service and identifies the content, and by modifying metadata of the content to reference the smart link and the agreed policy terms,
share, by the link service, the smart link and a password for accessing the content referenced by the smarterlink with the at least one user;
receive, by the link service, a request for a resource identified in the smart link, wherein the request is the result of the at least one user calling the smart link;
present, by the link service, a content-access user interface, the content-access user interface providing a password input field, the content-access user interface presenting the agreed policy terms;
receive, in the content-access user interface of the link service, the password to access the content identified by the smart link.

14. The computing system of claim 13, wherein the instructions further configure the computing system to:
provide, by the link service, access to the content in content-use service;
receive, by the link service, a request to use or modify the content;
determine, by the link service, that the agreed policy terms permit the use of modification of the content; and
allow the use or modification of the content in accordance with the agreed policy terms.

15. The computing system of claim 14, wherein the instructions further configure the computing system to:
provide access to the content by at content modification service when this is consistent with the agreed policy terms;
determine that the content has been modified into a derivative content;
prepare the derivative content for storage in the public cloud, wherein the metadata of the refers to the content and the agreed policy terms, whereby future use of the derivative content is controlled by the agreed policy terms.

16. The computing system of claim 15, wherein the instructions further configure the computing system to:
provide a smart link-management user interface to the rights holder, wherein the smart link-management user interface displays contents including the content and the derivative content controlled by the rights holder;
receive a modification to policy terms available for the content or a deletion of the smart link, whereby the modification is applied to further attempts to access the content.

17. A non-transitory computer-readable storage medium comprising instructions stored thereon that when executed, cause the at least one processor to:
receive, by a link service, a content and policy terms available for the content including at least one policy term;
map, by the link service, the policy terms available for the content into a policy embodied in a natural language format and a computer code format; and
store, by the link service, the content with the policy at a storage service, whereby the policy controls use of the content by a party accessing the content.

18. The non-transitory computer-readable storage medium of claim 17, wherein the instructions further cause the at least one processor to:
prepare, by the link service, the content for storage in a public cloud account of the link service at the public cloud, the preparing the content for storage in the public cloud includes:
adjust metadata for the content to include the policy as part of the metadata, and
adjust the metadata to include an ACL configuration to enable content-level access control at the public cloud, wherein access to the content at the public cloud account of the link service is controlled by the ACL configuration, wherein the ACL configuration is interpretable by the public cloud to permit persistent access to the content by parties that do not have access credentials to the public cloud account of the link service, wherein the policy terms available for the content and the ACL configuration are modifiable by the link service.

19. The non-transitory computer-readable storage medium of claim 17, wherein the instructions further cause the at least one processor to:
receive, by the link service, from a user, a request to obtain rights to the content;
interpret, by the link service, the policy terms available for the content;
present, by the link service, the policy terms available for the content;
receive, by the link service, an agreed policy terms, wherein the agreed policy terms can include the at least one policy term and/or include a custom negotiated policy term;
conduct, by the link service, a payment flow with the user to purchase a policy including the agreed policy terms.

20. The non-transitory computer-readable storage medium of claim 19, wherein the instructions further cause the at least one processor to:
create, by the link service, a smart link, by generating a password protected public link shared with at least one user that resolves to the link service and identifies the content, and by modifying metadata of the content to reference the smart link and the agreed policy terms,
share, by the link service, the smart link and a password for accessing the content referenced by the smarterlink with the at least one user;
receive, by the link service, a request for a resource identified in the smart link, wherein the request is the result of the at least one user calling the smart link;
present, by the link service, a content-access user interface, the content-access user interface providing a password input field, the content-access user interface presenting the agreed policy terms;
receive, in the content-access user interface of the link service, the password to access the content identified by the smart link.
